(19) United States
(12) Patent Application Publication
(10) Pub. No.: US 2026/0302780 A1
(43) Pub. Date: Oct. 1, 2026

(54) DRYING DEVICE, HEATER CONTROL METHOD, AND STORAGE MEDIUM

(71) Applicant: Shu UMEHARA, Kanagawa (JP)

(72) Inventor: Shu UMEHARA, Kanagawa (JP)

(73) Assignee: Ricoh Company, Ltd., Tokyo (JP)

(21) Appl. No.: 19/553,901

(22) Filed: Mar. 2, 2026

(30) Foreign Application Priority Data
Mar. 25, 2025 (JP) 2025-049952

(51) Int. Cl. H02J 3/01; F26B 3/30; H05B 1/02; H05B 3/00

(52) U.S. Cl. CPC H02J 3/01; H05B 1/023; H05B 3/0038; F26B 3/30; H05B 2203/005; H05B 2203/032

(57) ABSTRACT

A drying device includes multiple heaters and circuitry. The multiple heaters are driven by an alternating-current power supply to generate heat. The multiple heaters includes a first heater and a second heater other than the first heater. The circuitry repeatedly activates each of the multiple heaters in predetermined cycles corresponding to an AC cycle of the alternating-current power supply and shifts activation start timing between the first heater and the second heater by half the AC cycle of the alternating-current power supply.

### CROSS-REFERENCE TO RELATED APPLICATION

This patent application is based on and claims priority pursuant to 35 U.S.C. § 119(a) to Japanese Patent Application No. 2025-049952, filed on Mar. 25, 2025, in the Japan Patent Office, the entire disclosure of which is hereby incorporated by reference herein.

### BACKGROUND

### Technical Field

The present disclosure relates to a drying device, a heater control method, and a storage medium storing a plurality of instructions.

### Related Art

In the related art, a drying device includes multiple heaters and controls turn-on of the multiple heaters. The drying device changes a control mode so that the polarity of a current of an alternating current (AC) power supply is not biased to either a positive side (+) or a negative side (−) to reduce harmonic noise.

### SUMMARY

The present disclosure described herein provides an improved drying device including multiple heaters and circuitry. The multiple heaters are driven by an alternating-current power supply to generate heat. The multiple heaters includes a first heater and a second heater other than the first heater. The circuitry repeatedly activates each of the multiple heaters in predetermined cycles corresponding to an AC cycle of the alternating-current power supply and shifts activation start timing between the first heater and the second heater by half the AC cycle of the alternating-current power supply.

Further, the present disclosure described herein provides an improved heater control method and a non-transitory storage medium storing a plurality of instructions which, when executed by one or more processors, causes the one or more processors to perform the heater control method. The heater control method includes repeatedly activating each of multiple heaters including a first heater and a second heater in predetermined cycles corresponding to an AC cycle of an alternating-current power supply and shifting activation start timing between the first heater and the second heater by half the AC cycle of the alternating-current power supply.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of a drying device;

FIG. 2 is a diagram illustrating a waveform of a current flowing through each heater of the drying device of FIG. 1 in a case of a heater output value of 100% in a first embodiment of the present disclosure;

FIG. 3 is a diagram illustrating a waveform of a current flowing through each heater of the drying device of FIG. 1 in a case of a heater output value of 80% in the first embodiment;

FIG. 4 is a diagram illustrating a waveform of a current flowing through each heater of the drying device of FIG. 1 in a case of a heater output value of 45% in the first embodiment;

FIG. 5 is a diagram illustrating a waveform of a composite wave of a current flowing through each heater of the drying device of FIG. 1 in a case of a heater output value of 45% in the first embodiment;

FIGS. 6A and 6B are diagrams each illustrating a waveform of a current flowing through each heater of the drying device of FIG. 1 in a case of a heater output value of 45% in the first embodiment;

FIG. 7 is a diagram illustrating a composite wave of a current flowing through each heater of the drying device of FIG. 1 in a case of a heater output value of 45% in the first embodiment;

FIGS. 8A to 8D are diagrams each illustrating a waveform of a current flowing through each heater of the drying device of FIG. 1 in a case of a heater output value of 45% in a second embodiment of the present disclosure;

FIG. 9 is a diagram illustrating a composite wave of a current flowing through each heater of the drying device of FIG. 1 in a case of a heater output value of 45% in the second embodiment; and

FIG. 10 is a diagram illustrating an overall configuration of a drying device according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a comparative example, a drying device includes multiple heaters and controls turn-on of the multiple heaters. The drying device changes a control mode so that the polarity of a current of an alternating current (AC) power supply is not biased to either a positive side (+) or a negative side (−) to reduce harmonic noise. For example, a turn-on timing (i.e., an activation start timing) of the multiple heaters is shifted during one cycle of the AC power supply to reduce the polarity bias as a whole composite wave.

A device connected to a commercial power supply, which has a small power, can control the heaters with the technique in the comparative example. However, if a heater device having a large power, which uses dedicated power supply equipment, controls the heaters with the technique in the comparative example, zero-order and even-order harmonic noises may be generated due to a half-wave control mode in which the positive and negative polarities become asymmetrical with respect to the AC power supply. Due to the harmonic noise, a phenomenon called direct current (DC) magnetization occurs in a coil of a transformer of the equipment, which may cause magnetic saturation. If the magnetic saturation occurs, the inductance of the coil decreases, and thus a large current flows, which may cause the equipment to be damaged or the power supply to be shut down unexpectedly.

In view of the above-described circumstances, an object of the present disclosure is to provide a drying device, a heater control method, and a storage medium storing a plurality of instructions that can prevent harmonic noise.

A description is given below of a drying device, a heater control method, and a storage medium storing a plurality of instructions in detail with reference to the accompanying drawings.

### First Embodiment

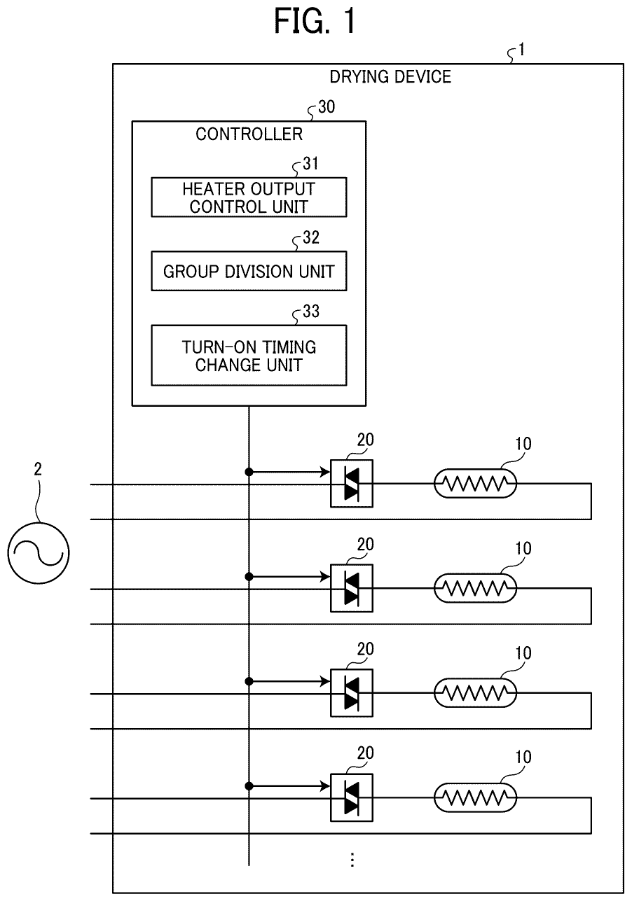

FIG. 1 is a diagram illustrating an overall configuration of a drying device 1 according to a first embodiment of the present disclosure. The drying device 1 includes multiple heaters 10, multiple turn-on control elements 20, and a controller 30. For example, the drying device 1 is mounted in an image forming apparatus to heat an object (e.g., a recording medium on which an image is formed) so as to dry the object. The drying device 1 is connected to an alternating current (AC) power supply 2. The AC power supply 2 is, for example, operated at a frequency of 50 Hz.

The heaters 10 as the multiple heaters are infrared (IR) heaters (e.g., IR lamps). Examples of the IR heater include, but are not limited to, a carbon heater, a tungsten heater, a halogen heater, and a ceramic heater.

The turn-on control element 20 is a switching element that switches whether to pass or block the current from the AC power supply 2 to the corresponding heater 10 in accordance with a control signal from the controller 30.

The turn-on control element 20 is, for example, a solid state relay (SSR), and can control zero-cross switching in which the corresponding heater 10 is turned on and off at a timing when the current becomes 0. As the turn-on control element 20, a switching element such as a photocoupler or a thyristor may be used instead of the SSR.

The controller 30 is an example of a “control unit” or circuitry. The controller 30 controls the entire operation of the drying device 1, and repeatedly controls the turn-on of (i.e., activates) each of the multiple heaters 10 in predetermined cycles. For example, the predetermined cycle is defined as a value of an integral multiple of the cycle of the AC power supply 2. In the following description, the predetermined cycle is 200 ms, which is 10 times the cycle of 20 ms of the AC power supply 2 operated at the frequency (cycle) of 50 Hz. A description is given below of a functional configuration of the controller 30.

As illustrated in FIG. 1, the controller 30 includes a heater output control unit 31, a group division unit 32, and a turn-on timing change unit 33. In FIG. 1, the controller 30 has, but is not limited to, the functions of the heater output control unit 31, the group division unit 32, and the turn-on timing change unit 33, which are described below, and the controller 30 may include other units having other functions. The controller 30 includes at least a processor and a memory as a hardware configuration. For example, the memory stores a program, and the processor executes the program stored in the memory to implement the functions of the above-described units. However, the hardware configuration is not limited thereto, and some or all of these functions are implemented by dedicated hardware circuitry (such as a semiconductor integrated circuit).

The heater output control unit 31 controls the output of each heater 10 according to a heater output value set by a user. The heater output value indicates a ratio of a time period during which each heater 10 is energized to the predetermined cycle. The heater output control unit 31 energizes each heater 10 for the time period and controls the output of each heater 10 based on the heater output value in the predetermined cycles of 200 ms. The time period is an integer multiple of a half-wavelength period of the AC power supply 2.

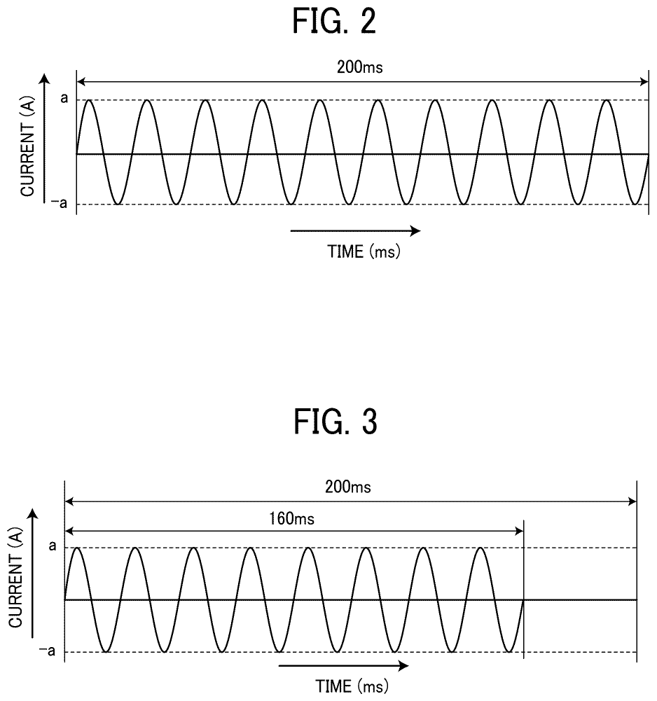

For example, when the heater output value is 100%, the heater output control unit 31 constantly energizes each heater 10 during the predetermined cycle of 200 ms. FIG. 2 is a diagram illustrating a waveform of a current flowing through each heater 10 in a case of the heater output value of 100%. In FIG. 2, the horizontal axis represents time (ms), the vertical axis represents current (A), and a represents the amplitude of the current flowing through the heater 10. In FIGS. 3 to 9 described below, similarly to FIG. 2, the horizontal axis represents time (ms), the vertical axis represents current (A), and a represents the amplitude of the current flowing through the heater 10.

For example, when the heater output value is 80%, the heater output control unit 31 energizes each heater 10 during a time period of 160 ms corresponding to 80% of the predetermined cycle of 200 ms. FIG. 3 is a diagram illustrating a waveform of a current flowing through each heater 10 when the heater output value is 80%.

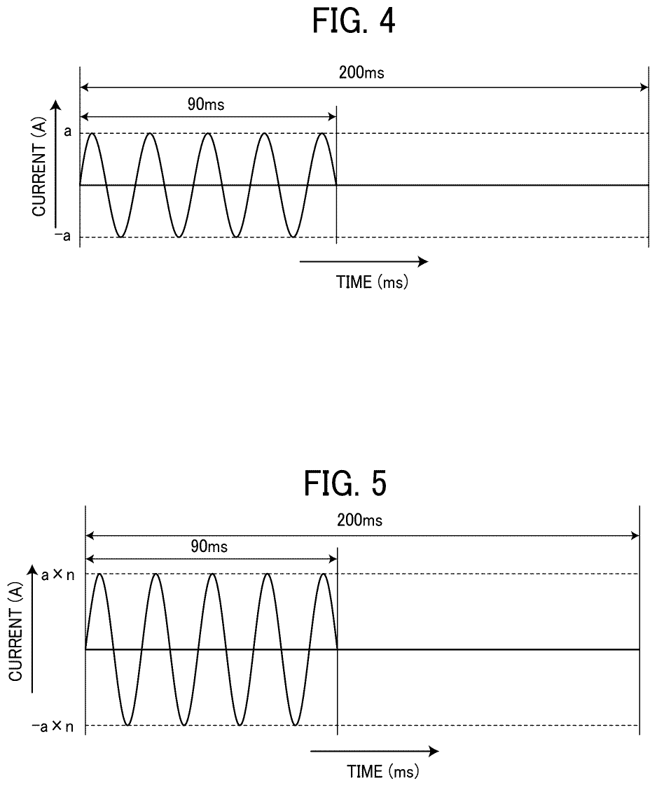

For example, when the heater output value is 45%, the heater output control unit 31 energizes each heater 10 during a time period of 90 ms corresponding to 45% of the predetermined cycle of 200 ms. FIG. 4 is a diagram illustrating a waveform of a current flowing through each heater 10 when the heater output value is 45%.

As illustrated in FIG. 4, for example, when the heater output value is 45%, the polarity of the current flowing through each heater 10 is asymmetrical between positive and negative. For example, in FIG. 4, the polarity of the current flowing through each heater 10 is biased to the positive polarity (+) by a half wavelength of the AC power supply 2.

FIG. 5 is a diagram illustrating a waveform of a composite wave of currents flowing through the n heaters 10 included in the drying device 1 when the heater output value is 45%. As illustrated in FIG. 5, when the current having the waveform illustrated in FIG. 4 flows through each of the n heaters 10, the polarity of the composite wave of the currents flowing through all of the n heaters 10 is greatly biased to the positive polarity (+). As a result, the zero-order and even-order harmonic noises may be generated.

The group division unit 32 divides the multiple heaters 10 into a first group that starts the turn-on (i.e., starts activating the first group of heaters) from the positive polarity of the AC power supply 2 and a second group that starts the turn-on (i.e., starts activating the first second group of heaters) from the negative polarity of the AC power supply 2. Specifically, when the number of heaters 10 is an even number, the group division unit 32 divides the multiple heaters 10 so that the number of heaters 10 in the first group is the same as the number of heaters 10 in the second group. When the number of heaters 10 is an odd number, the group division unit 32 divides the multiple heaters 10 so that the number of heaters 10 in the first group is larger or smaller by one than the number of heaters 10 in the second group.

The turn-on timing change unit 33 shifts a turn-on timing (i.e., an activation start timing) of each of the multiple heaters 10 by half the cycle (i.e., the AC cycle) of the AC power supply 2. In other words, the turn-on timing change unit 33 shifts a turn-on timing of a part of the multiple heaters 10 (e.g., a first heater) with respect to another part of of the multiple heaters 10 (e.g., a second heater) by half the cycle of the AC power supply 2. In the first embodiment, the turn-on timing change unit 33 shifts the turn-on timing of the heaters 10 included in either one of the first group or the second group by half the cycle of the AC power supply 2. In the following description, the turn-on timing change unit 33 shifts the turn-on timing of the heater 10 included in the second group by 10 ms, which is half of the cycle of the AC power supply 2.

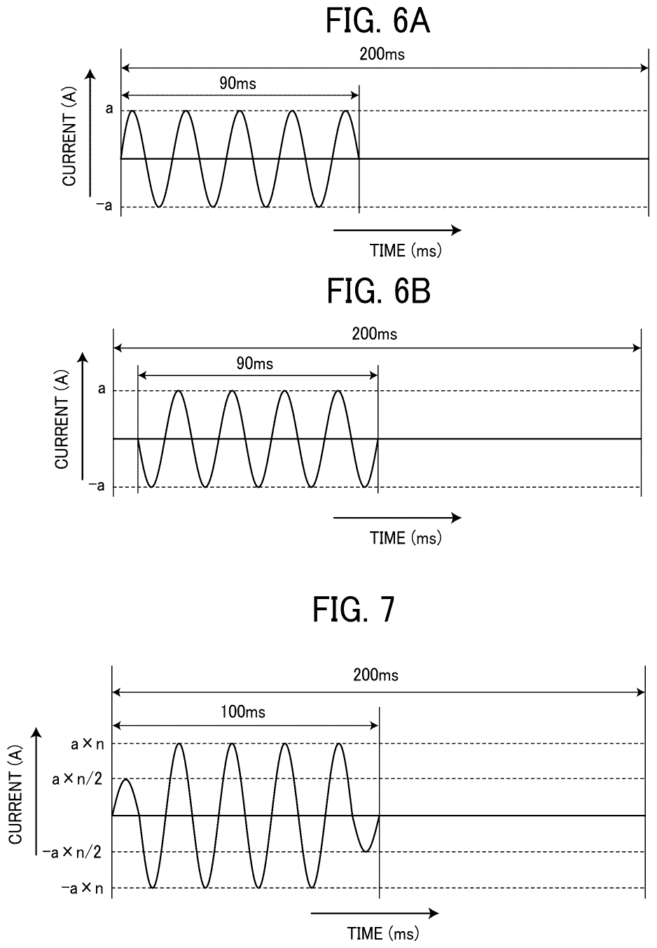

FIGS. 6A and 6B are diagrams each illustrating a waveform of a current flowing through each heater 10 when the turn-on timing change unit 33 shifts the turn-on timing of the heater 10 by half the cycle of the AC power supply 2 in a case of the heater output value of 45%. FIG. 6A illustrates a waveform of a current flowing through the heater 10 included in the first group in which the turn-on timing change unit 33 does not shift the turn-on timing. FIG. 6B illustrates a waveform of a current flowing through the heater 10 included in the second group in which the turn-on timing change unit 33 shifts the turn-on timing by half the cycle of the AC power supply 2.

FIG. 7 is a diagram illustrating a composite wave of all of the n heaters 10 included in the drying device 1 when the controller 30 performs the above-described control in the first embodiment. The composite wave illustrated in FIG. 7 is a waveform when n is an even number. As illustrated in FIG. 7, the composite wave of all of the n heaters 10 has no polarity bias, and the drying device 1 controls the waveform symmetrically between the positive polarity and the negative polarity (i.e., positive/negative symmetric control). Accordingly, the drying device 1 according to the first embodiment can reduce the harmonic noise.

In the above control, when the number n of the heaters 10 included in the drying device 1 is an odd number, one waveform is not paired, and thus the polarity of the composite wave is slightly biased by a bias of only one heater 10. Accordingly, even in this case, the drying device 1 can perform control close to the positive/negative symmetric control, and thus the above-described effect in the first embodiment is not limited to the case where n is an even number.

### Second Embodiment

A description is given below of a second embodiment of the present disclosure. Descriptions of portions in common with the first embodiment as described above will be omitted as appropriate.

In the second embodiment, the controller 30 includes the heater output control unit 31 and the turn-on timing change unit 33. The function of the heater output control unit 31 is the same as that in the first embodiment described above, and therefore, a detailed description is omitted.

In the second embodiment, the turn-on timing change unit 33 shifts the turn-on timings of all the multiple heaters 10 with respect to one another by half the cycle of the AC power supply 2.

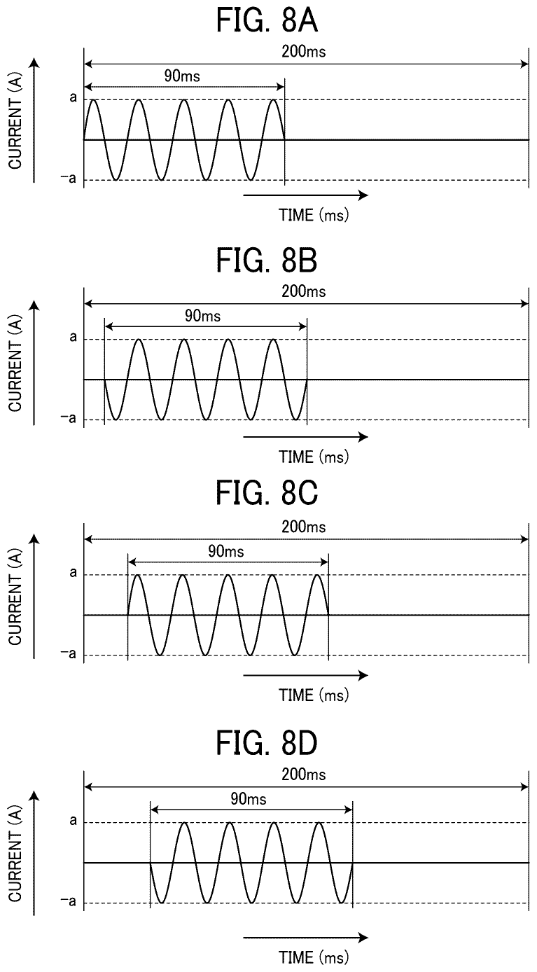

FIGS. 8A to 8D are diagrams each illustrating a waveform of a current flowing through each heater 10 when the turn-on timing change unit 33 shifts the turn-on timing of the four heaters 10 with respect to one another by half the cycle of the AC power supply 2 in a case of the heater output value of 45%.

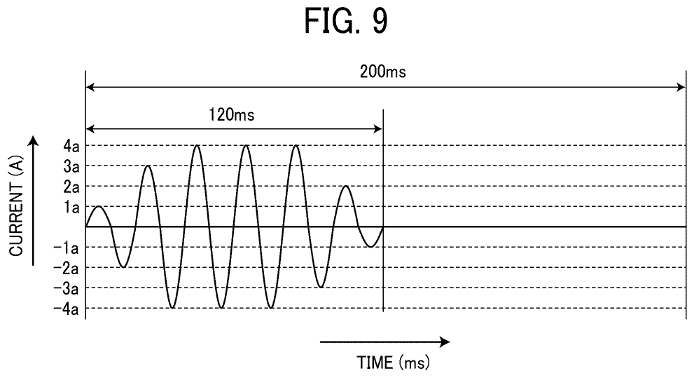

FIG. 9 is a diagram illustrating a composite wave of all the four heaters 10 when the turn-on timing change unit 33 performs the above-described control. As illustrated in FIG. 9, similarly to the first embodiment, the composite wave of all of the four heaters 10 as a whole has no polarity bias, and the drying device 1 performs the positive/negative symmetric control. In the second embodiment, the rising of the waveform of the composite wave is gradual. Typically, when the current flowing through the circuit changes more rapidly, the harmonic noise is more likely to occur, and thus the drying device 1 according to the second embodiment is more effective in preventing the harmonic noise than the drying device 1 according to the first embodiment. Accordingly, the drying device 1 according to the second embodiment can more effectively reduce the harmonic noise.

In the above control, the number of heaters 10 to be controlled is four, but the number of heaters 10 is not limited thereto. As the number of heaters 10 to be controlled increases, the rising of the waveform of the composite wave by the above control becomes more gradual, and thus the effect of preventing harmonic noise becomes higher.

Further, similarly to the first embodiment, when the number of heaters 10 to be controlled is an odd number, one waveform is not paired, and thus the polarity of the composite wave is biased by a bias corresponding to one heater 10. Accordingly, even in this case, the drying device 1 can perform control close to the positive/negative symmetric control, and thus the above-described effect in the second embodiment is not limited to the case where the number of heaters 10 to be controlled is an even number.

As described above, the drying device 1 according to the first and second embodiments shifts the turn-on timing of each of the multiple heaters 10 by half the cycle of the AC power supply 2 during the predetermined cycle to reduce the bias of the polarity as the composite wave of all of the multiple heaters 10.

Accordingly, the drying device 1 can perform control that is close to the positive/negative symmetrical control with respect to the AC power supply to reduce harmonic noise.

Although the embodiments have been described above, the above-described embodiments are presented as examples and are not intended to limit the scope of the disclosure. The above-described novel embodiments can be implemented in other various forms, and various omissions, replacements, and changes can be made without departing from the scope of the present disclosure. Such novel embodiments and variations thereof are included in the scope and gist of the present disclosure and are included in the scope of the appended claims and the equivalent scope thereof.

In addition, the effects of the embodiments described in the present disclosure are merely examples and are not limited, and other effects may be obtained by the above-described embodiments.

A modification will be described below.

### Modification

Although the drying device 1 according to the first embodiment and the second embodiment described above is connected to the single-phase AC power supply 2, a drying device according to a modification may be connected to a three-phase AC power supply.

For example, the drying device according to the modification may include multiple heaters including at least one three-phase heater, and a controller.

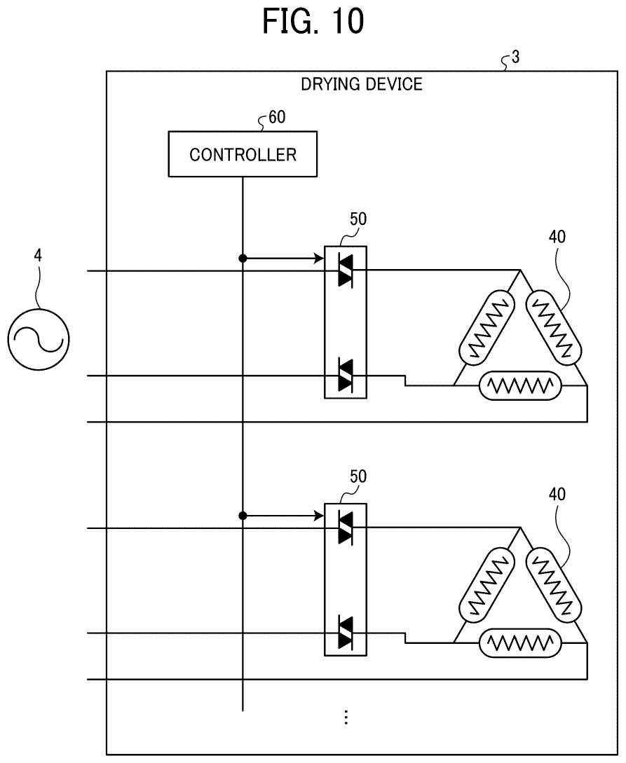

FIG. 10 is a diagram illustrating an overall configuration of a drying device 3 according to the modification. As illustrated in FIG. 10, the drying device 3 includes multiple three-phase heaters 40, multiple turn-on control elements 50, and a controller 60. The drying device 3 is connected to a three-phase AC power supply 4. The three-phase AC power supply 4 is, for example, operated at a frequency of 50 Hz.

In the three-phase heater 40, three heaters are connected to each other, and each three-phase heater 40 is connected to the three-phase AC power supply 4 via three feeder lines including a first electric wire, a second electric wire, and a third electric wire.

The turn-on control element 50 is, for example, a two-element SSR, and is a switching element that switches whether to pass or block the current from the three-phase AC power supply 4 to the corresponding three-phase heater 40 in accordance with a control signal from the controller 60.

The controller 60 controls the current of at least any two electric wires of the first electric wire, the second electric wire, and the third electric wire that connect the three-phase AC power supply 4 and each of the three-phase heaters 40. In the configuration illustrated in FIG. 10, the controller 60 controls the currents of two electric wires among the first, second, and third electric wires connecting the three-phase AC power supply 4 and the three-phase heaters 40 via the turn-on control element 50.

In the drying device 3 according to the above modification, the controller 60 can perform control similar to that of the drying device 1 according to the first and second embodiments described above.

The program executed by the drying device 1 and the drying device 3 according to the above-described embodiments may be stored in a computer-readable recording medium, such as a compact disc-read-only memory (CD-ROM), a flexible disk (FD), a compact disc-recordable (CD-R), and a digital versatile disc (DVD), in an installable or executable file format, to be provided.

Alternatively, the programs executed by the drying device 1 and the drying device 3 according to the above-described embodiments may be stored in a computer connected to a network such as the Internet and downloaded via the network, to be provided. The program executed by the drying device 1 and the drying device 3 according to the above-described embodiments may be provided or distributed via a network such as the Internet.

The program executed by the drying device 1 and the drying device 3 according to the above-described embodiments has a module configuration including the above-described components (e.g., the heater output control unit, the group division unit, and the turn-on timing change unit). In terms of actual hardware, the processor such as a central processing unit (CPU) reads the program from the memory such as a read-only memory (ROM) and executes the program to load the components onto a main storage device so as to implement the heater output control unit, the group division unit, and the turn-on timing change unit on the main storage device.

Aspects of the present disclosure are, for example, as follows.

### Aspect 1

A drying device includes multiple heaters, and a controller that repeatedly controls turn-on of each of the multiple heaters in a predetermined cycle. The controller shifts a turn-on timing of each of the multiple heaters by half a cycle of an alternating current power supply.

In other words, a drying device includes multiple heaters and circuitry. The multiple heaters are driven by an alternating-current power supply to generate heat. The multiple heaters includes a first heater and a second heater other than the first heater. The circuitry repeatedly activates each of the multiple heaters in predetermined cycles corresponding to an AC cycle of the alternating-current power supply and shifts activation start timing between the first heater and the second heater by half the AC cycle of the alternating-current power supply.

### Aspect 2

In the drying device according to Aspect 1, the controller (circuitry) divides the multiple heaters into a first group that starts the turn-on from a positive polarity of the alternating current power supply and a second group that starts the turn-on from a negative polarity of the alternating current power supply, and shifts the turn-on timing of the multiple heaters included in either one of the first group or the second group by half the cycle of the alternating current power supply.

In other words, the multiple heaters include a first group of heaters including the first heater and a second group of heaters including the second heater. The circuitry starts activating the first group of heaters from a positive polarity of the alternating-current power supply, starts activating the second group of heaters from a negative polarity of the alternating-current power supply, and shifts the activation start timing between the first group and the second group by half the AC cycle of the alternating-current power supply.

### Aspect 3

In the drying device according to Aspect 2, when a number of the multiple heaters is an even number, a number of the multiple heaters included in the first group is the same as a number of the multiple heaters included in the second group.

In other words, when a number of the multiple heaters is an even number, the circuitry sets a number of the first group of heaters to be the same as a number of the second group of heaters.

### Aspect 4

In the drying device according to Aspect 2, when a number of the multiple heaters is an odd number, a number of the multiple heaters included in the first group is larger or smaller by one than a number of the multiple heaters included in the second group.

In other words, when a number of the multiple heaters is an odd number, the circuitry sets a number of the first group of heaters to be larger or smaller by one than a number of the second group of heaters.

### Aspect 5

In the drying device according to Aspect 1, the controller (circuitry) shifts the turn-on timing of all of the multiple heaters with respect to one another by half the cycle of the alternating current power supply.

In other words, the circuitry shifts the activation start timing of all the multiple heaters from one another by half the AC cycle of the alternating-current power supply.

### Aspect 6

In the drying device according to any one of Aspects 1 to 5, the multiple heaters include at least one three-phase heater, and the controller controls currents of at least any two electric wires of a first electric wire, a second electric wire, and a third electric wire that connect a three-phase power supply and the three-phase heater, respectively.

In other words, the drying device according to any one of Aspects 1 to 5, further includes a first electric wire, a second electric wire, and a third electric wire. The multiple heaters include at least one three-phase heater connected to a three-phase alternating current power supply via the first electric wire, the second electric wire, and the third electric wire. The circuitry controls currents flowing through at least two of the first electric wire, the second electric wire, or the third electric wire.

### Aspect 7

A heater control method, which is executed by a drying device including multiple heaters and a controller that repeatedly controls turn-on of each of the multiple heaters in predetermined cycles, includes shifting a turn-on timing of each of the multiple heaters by half a cycle of an alternating current power supply.

In other words, a heater control method includes repeatedly activating each of multiple heaters including a first heater and a second heater in predetermined cycles corresponding to an AC cycle of an alternating-current power supply and shifting activation start timing between the first heater and the second heater by half the AC cycle of the alternating-current power supply.

### Aspect 8

A program causes a drying device including multiple heaters and a controller that repeatedly controls turn-on of each of the multiple heaters in predetermined cycles to execute a step of shifting a turn-on timing of each of the multiple heaters by half a cycle of an alternating current power supply.

In other words, a non-transitory storage medium stores a plurality of instructions which, when executed by one or more processors, causes the one or more processors to perform a method. The method includes repeatedly activating each of multiple heaters including a first heater and a second heater in predetermined cycles corresponding to an AC cycle of an alternating-current power supply and shifting activation start timing between the first heater and the second heater by half the AC cycle of the alternating-current power supply.

As described above, according to one aspect of the present disclosure, an effect of reducing harmonic noise in the drying device can be achieved.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A drying device comprising:
multiple heaters driven by an alternating-current power supply to generate heat, the multiple heaters including:
a first heater; and
a second heater other than the first heater; and
circuitry configured to:
repeatedly activate each of the multiple heaters in predetermined cycles corresponding to an AC cycle of the alternating-current power supply; and
shift activation start timing between:
the first heater; and
the second heater,
by half the AC cycle of the alternating-current power supply.

2. The drying device according to claim 1,
wherein the multiple heaters include:
a first group of heaters including the first heater; and
a second group of heaters including the second heater, and
the circuitry is further configured to:
start activating the first group of heaters from a positive polarity of the alternating-current power supply;
start activating the second group of heaters from a negative polarity of the alternating-current power supply; and
shift the activation start timing between the first group and the second group by half the AC cycle of the alternating-current power supply.

3. The drying device according to claim 2,
wherein the circuitry is further configured to, when a number of the multiple heaters is an even number:
set a number of the first group of heaters to be the same as a number of the second group of heaters.

4. The drying device according to claim 2,
wherein the circuitry is further configured to, when a number of the multiple heaters is an odd number:
set a number of the first group of heaters to be larger or smaller by one than a number of the second group of heaters.

5. The drying device according to claim 1,
wherein the circuitry is further configured to:
shift the activation start timing of all the multiple heaters from one another, by half the AC cycle of the alternating-current power supply.

6. The drying device according to claim 1, further comprising:
a first electric wire;
a second electric wire; and
a third electric wire,
wherein the multiple heaters include at least one three-phase heater connected to a three-phase alternating current power supply via the first electric wire, the second electric wire, and the third electric wire, and
the circuitry is further configured to control currents flowing through at least two of the first electric wire, the second electric wire, or the third electric wire.

7. A heater control method comprising:
repeatedly activating each of multiple heaters including a first heater and a second heater in predetermined cycles corresponding to an AC cycle of an alternating-current power supply; and
shifting activation start timing between:
the first heater; and
the second heater,
by half the AC cycle of the alternating-current power supply.

8. A non-transitory storage medium storing a plurality of instructions which, when executed by one or more processors, causes the one or more processors to perform a method, comprising:
repeatedly activating each of multiple heaters including a first heater and a second heater in predetermined cycles corresponding to an AC cycle of an alternating-current power supply; and
shifting activation start timing between:
the first heater; and
the second heater,
by half the AC cycle of the alternating-current power supply.

9. The drying device according to claim 2, further comprising:
a first electric wire;
a second electric wire; and
a third electric wire,
wherein the multiple heaters include at least one three-phase heater connected to a three-phase alternating current power supply via the first electric wire, the second electric wire, and the third electric wire, and
the circuitry is further configured to control currents flowing through at least two of the first electric wire, the second electric wire, or the third electric wire.

10. The drying device according to claim 3, further comprising:
a first electric wire;
a second electric wire; and
a third electric wire,
wherein the multiple heaters include at least one three-phase heater connected to a three-phase alternating current power supply via the first electric wire, the second electric wire, and the third electric wire, and
the circuitry is further configured to control currents flowing through at least two of the first electric wire, the second electric wire, or the third electric wire.

11. The drying device according to claim 4, further comprising:
a first electric wire;
a second electric wire; and
a third electric wire,
wherein the multiple heaters include at least one three-phase heater connected to a three-phase alternating current power supply via the first electric wire, the second electric wire, and the third electric wire, and
the circuitry is further configured to control currents flowing through at least two of the first electric wire, the second electric wire, or the third electric wire.

12. The drying device according to claim 5, further comprising:
a first electric wire;
a second electric wire; and
a third electric wire,
wherein the multiple heaters include at least one three-phase heater connected to a three-phase alternating current power supply via the first electric wire, the second electric wire, and the third electric wire, and
the circuitry is further configured to control currents flowing through at least two of the first electric wire, the second electric wire, or the third electric wire.
